(19) United States
(12) Patent Application Publication
(10) Pub. No.: US 2012/0219264 A1
(43) Pub. Date: Aug. 30, 2012

(54) IMAGE PROCESSING DEVICE

(75) Inventor: Takashi KURIYAMA, Yokohama-shi (JP)

(73) Assignee: NIKON CORPORATION, TOKYO (JP)

(21) Appl. No.: 13/401,360

(22) Filed: Feb. 21, 2012

(30) Foreign Application Priority Data
Feb. 25, 2011 (JP) 2011-039633
Jan. 20, 2012 (JP) 2012-010043

(51) Int. Cl. G11B 27/00; H04N 5/775

(52) U.S. Cl. 386/230; 386/280; 386/E05.028; 386/E05.07

(57) ABSTRACT

Image processing unit for executing, on movie images that have been recorded in a recording medium, image processing of at least one of imparting or removing an electronic zoom effect, or imparting or removing an electronic blurring effect; a first setting unit that sets, in the movie images, a processing section in which the image processing is to be executed by the image processing unit; a second setting unit that sets, for the processing section in the movie images, at least one of either the zoom factor processing or the amount of blurring having time-series changes to be imparted by the second image processing; and a movie image data creation unit that creates movie image data including the movie images on which the image processing has been performed by the image processing unit, on the basis of the content set by the first setting unit and the second setting unit.

### CROSS-REFERENCE TO RELATED APPLICATIONS

The disclosures of the following priority applications are herein incorporated by reference:

Japanese Patent Application No. 2011-039633 filed on Feb. 25, 2011: and

Japanese Patent Application No. 2012-010043 filed on Jan. 20, 2012.

### TECHNICAL FIELD

The present invention relates to an image processing device permitting the playback of movie images.

### BACKGROUND ART

There has been proposed an image processing device for permitting the automatic addition of image blur when a shooting scene mode is set to a portrait mode, for adding image blur to a through-image in a case where a half-depression operating signal is inputted, and for releasing the addition of the image blur to the through-image when the half-depression operating signal is no longer inputted (e.g., see Patent Literature 1). Such an image processing device adds image blur to a background region of the primary subject, and also adds, to a main imaging image obtained in accordance with a full-depression operating signal, an image blur similar to the image blur added to the through-image immediately prior to when the full-depression operating signal is inputted.

### CITATION LIST

### Patent Literature

Patent Literature 1: Japanese Unexamined Patent Application Publication. No. 2007-124279

### SUMMARY OF INVENTION

### Technical Problem

However, although the above Patent Literature 1 discloses a technique for adding image blur to the background region of the principal subject or other predetermined region, no disclosure is made of a technique for performing processing for adding image blur to the overall image and simultaneously performing processing for enlarging the image.

In recent years there has been a desire for a technique permitting the simple acquisition of movie images having impressive visual effects, such as movie images in which, for example, there is a gradual change from an unfocused, zoomed-in state to a state of zooming out while also focusing on the subject. However, advanced operating technology is needed in a case where a user wishes to manually operate a video camera or the like to shoot movie images having such an impressive visual effect as described above.

It is an object of the present invention to provide an image processing device by which it is possible to readily create movie images having an impressive visual effect from already-captured movie images.

### Solution to Problem

The image processing device of the present invention is characterized by comprising: an image processing unit that executes, on movie images that have been recorded in a recording medium, image processing of at least one of a first image processing for imparting or removing an electronic zoom effect, or a second image processing for imparting or removing an electronic blurring effect; a first setting unit that sets, in the movie images, a processing section in which the image processing is to be executed by the image processing unit; a second setting unit that sets, for the processing section in the movie images, at least one of either the zoom factor having time-series changes to be imparted by the first image processing or the amount of blurring having time-series changes to be imparted by the second image processing; and a movie image data creation unit that creates movie image data including the movie images on which the image processing has been performed by the image processing unit, on the basis of the content set by the first setting unit and the second setting unit.

### Advantageous Effects of Invention

According to the image processing device of the present invention, it is possible to readily create movie images having an impressive visual effect from already-captured movie images.

### BRIEF DESCRIPTION OF DRAWINGS

FIG. 1 is a block diagram illustrating the configuration of the system of an image processing device according to the embodiments;

FIG. 2 is a flow chart adapted to describe the processing for creating and playing back a scenario movie in the image processing device according to the embodiments;

FIG. 3 is a timing chart adapted to describe the processing for creating a scenario movie in the image processing device according to the embodiments;

FIG. 4 is a drawing illustrating an example of the display of a display unit according to the embodiments;

FIG. 5 is a graph illustrating the relationship between the zoom factor and the amount of blurring;

FIG. 6 is a graph illustrating the relationship between the zoom factor and the spatial frequency band;

FIG. 7 is a graph illustrating the relationship between the zoom factor and the spatial frequency band;

FIG. 8 is a flowchart adapted to describe the processing for creating a scenario movie in the image processing device according to the embodiments;

FIG. 9 is a diagram illustrating a zoom processing section and a blurring processing section relative to a movie image; and

FIG. 10 is a diagram illustrating a zoom processing section and a blurring processing section relative to a movie image.

### DESCRIPTION OF EMBODIMENTS

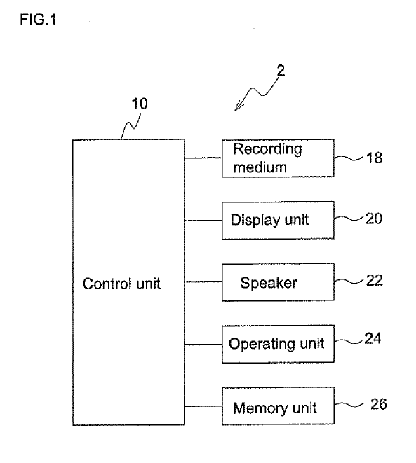

The following is a description of an image processing device according to a first embodiment of the present invention, with reference to the accompanying drawings. FIG. 1 is a block diagram illustrating the configuration of the system of an image processing device 2 according to this embodiment. An “image processing device” refers to a device having image processing functions for performing processing on movie image data or still image data recorded in a recording medium or the like; examples include a personal computer (PC), a digital camera or other imaging device, a mobile telephone, or the like. In this embodiment, the image processing device 2 is described as being a PC. As illustrated in FIG. 1, the image processing device 2 is provided with a control unit 10 that generally controls each of the units of the image processing device 2, which is constituted of a CPU and other elements. The control unit 10 is connected to a recording medium 18, a display unit 20, a speaker 22, an operating unit 24, and a memory unit 26.

The recording medium 18 is a memory that is built into the image processing device 2 or is a memory card or the like that is detachably fitted into a slot (not shown) provided to the image processing device 2; the recording medium 18 records: movie image data, still image data, and audio data captured by a digital camera or a video camera; movie image data, still image data, and audio data acquired from a Web server present on the Internet or other network connected via a network terminal (not shown) provided to the image processing device 2; or the like.

The display unit 20 is constituted of a monitor constituted of an LCD or the like, and displays movie images based on movie image data recorded in the recording medium 18, or still images based on still image data recorded therein, or the like. The speaker 22 outputs audio based on the audio data recorded in the recording medium 18. The operating unit 24 is configured to include a power source switch for turning on and off the power source of the image processing device 2; a key board and a pointing device operated whenever various forms of processing are executed; and the like. The memory unit 26 stores a plurality of frame images or the like for forming a movie image at times such as when the display unit 20 displays movie images based on image data recorded in the recording medium 18.

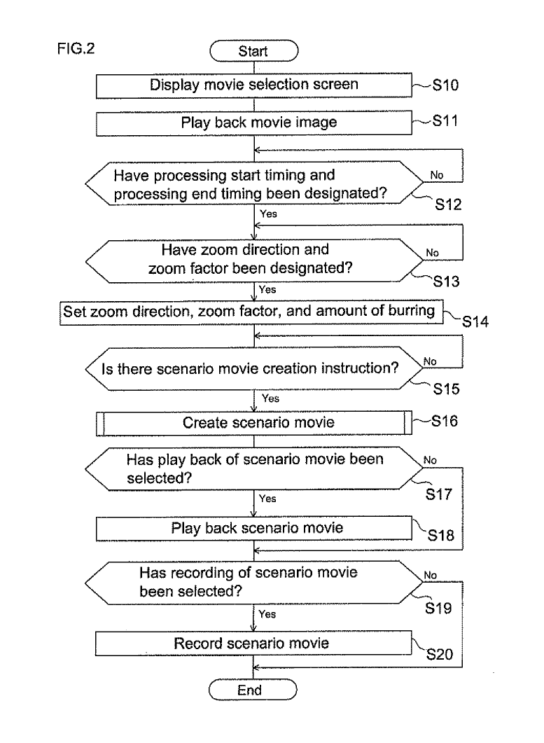

The image processing device 2 according to this embodiment uses the movie image data recorded in the recording medium 18 to create movie images in which there is a gradual change from a zoomed-in, unfocused state (a blurred state) to a state of zooming out while also focusing on the subject, or alternatively in which there is a gradual change from a zoomed-out state focused on the subject to a state of zooming in while also unfocusing (hereinafter referred to as “scenario movies”). The image processing device 2 also plays back the created scenario movies. The following is a description of the processing for creating the scenario movie and the processing for playing back the scenario movie in the image processing device 2 according to the first embodiment, with reference to the flowchart illustrated in FIG. 2.

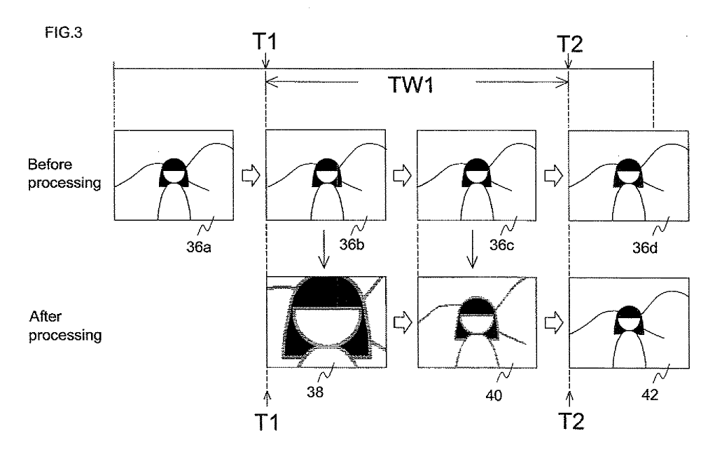

FIG. 2 is a flowchart adapted to describe the processing for creating and the processing for playing back the scenario movie, and FIG. 3 is a drawing adapted to describe the processing for creating and the processing for playing back the scenario movie.

First, the control unit 10 displays, on the display unit 20, a movie selection screen adapted to cause a user to select one of a plurality of movie image data sets based on movie images intended to create the scenario movie, i.e., movie image data sets recorded in the recording medium 18 (step S10). Specifically, the display unit 20 displays a list of movie image data sets recorded in the recording medium 18, e.g., a list of filenames of the movie image data sets or a list of thumbnail images of representative frame images among the plurality of frame images forming the movie images; and the user is made to select one movie image data set via the operating unit 24.

When a single movie image data set is selected via the operating unit 24 by the user, the control unit 10 performs buffering in the memory unit 26 with the selected movie image data set (hereinafter referred to as the original movie image data set) and the audio data set corresponding to the original movie image data set (hereinafter referred to as the original audio data set). In a case where the selected movie image data set is MPEG2, H.264, and other compressed form of video data, the control unit 10 performs the buffering in the memory unit 26 after having decompressed the movie image data. Then, the control unit 10 performs resizing processing for display purposes on the movie images based on the movie image data set buffered in the memory unit 26 (hereinafter, the original movie images) and then displays the same on the display unit 20, also playing back audio based on the audio data set (hereinafter, the original audio) in the speaker 22 (step S11). Then, the control unit 10 causes the user to designate, via the operating unit 24, a processing start timing and a processing end timing. The processing start timing indicates the time when zoom processing and blurring processing begin, i.e., the time of the most zoomed-in, unfocused state (the blurred state), or the time of the most zoomed-out state focused on the subject; the user designates which state is to be done. The processing end timing indicates the time when the zooming processing and blurring processing end, i.e., in a case where the processing start timing is the time of the most zoomed-in, unfocused state, then the processing end timing indicates the time of the most zoomed-out state focused on the subject, and in a case where the processing start timing is the time of the most zoomed-out state focused on the subject, then, the processing end timing indicates the time of the most zoomed-in, unfocused state.

Specifically, as illustrated in FIG. 3, the user views the original movie images 36a to 36d displayed on the display unit 20 and listens to the original audio played back by the speaker 22 while using the operating unit 24 to designate the processing start timing T1 and the processing end timing T2. Namely, a processing section is designated by the processing start timing T1 and the processing end timing T2. At this time, the processing end timing T2 may be designated after a frame advance playback function, fast-forward playback function, rewind playback function, or the like is used to designate the processing start timing T1; alternatively, the processing start timing T1 may be designated after the processing end timing T2 is designated. In a case where the playback period of the original movie images 36a to 36d is short (for example, 5 seconds or less), then rather than the user being made to designate the processing start timing T1 and the processing end timing T2, another possible configuration is for the control unit 10 to automatically set the time when the original movie images start to the processing start timing T1 and to set the time when the original movie images end to the processing end timing T2. Another possible configuration is one such that a period of time TW1 from the processing start timing T1 to the processing end timing T2 is pre-set, and when either one of the processing start timing T1 or the processing end timing T2 is designated by the user, the other one of the processing end timing T2 or the processing start timing T1 is automatically set.

The control unit 10 determines whether or not the processing start timing T1 and the processing end timing T2 have been designated by the user (step S12); in a case where the determination in step S12 is that the processing start timing T1 and the processing end timing T2 have been designated (“Yes” in step S12), then the user is made to designate, via the operating unit 24, a zoom direction and zoom factor (magnification rate or reduction rate). The zoom direction indicates whether to transition from zoomed in to zooming out, or from zoomed out to zooming in, and the zoom factor indicates the angle of view of the original movie images (zoomed-out state) relative to the angle of view when zoomed in (zoomed-in state).

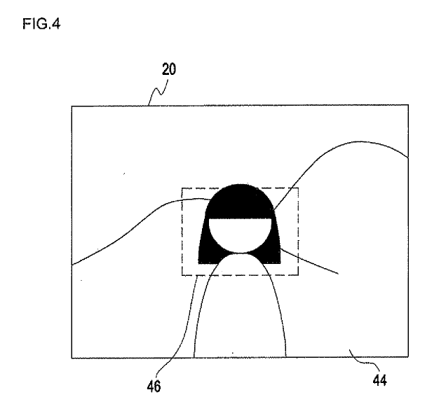

Specifically, the control unit 10 displays, on the display unit 20, a selection screen for selecting, for example, “From zoomed in to zooming out” or “From zoomed out to zooming in” as the zoom direction, and then causes the user to select either one. The control unit 10 also, for example, displays, on the display unit 20, a screen for inputting a value as the zoom factor, and causes the user to input the value via the operating unit 24. Alternatively, instead of the value being inputted as the zoom factor, the control unit 10 can also display, on the display screen of the display unit 20, a screen 44 adapted to designate the zoom factor such as, for example, illustrated in FIG. 4, and then can cause the user to designate the zoom factor. The screen 44 displays a designation box 46 (shown with the dotted line) adapted for setting the angle of view when zoomed in, on a frame image 36b at the processing start timing T1 in a case of “From zoomed in to zooming out” or on a frame image 36c at the processing end timing T2 in a case of “From zoomed out to zooming in”; the user designates the zoom factor (the angle of view when zoomed in) by changing the size and the position of the designation box 46 on the frame image 36b or 36c. The shape of the designation box 46 is necessarily analogous to the shape of the display screen of the display unit 20.

The control unit 10 determines whether or not the zoom direction and the zoom factor have been designated by the user (step S13); in a case where the determination in step S13 is that the zoom direction and the zoom factor have been designated (“Yes” in step S13), then the zoom direction, the zoom factor, and the amount of blurring are set (step S14) on the basis of the zoom direction and the zoom factor designated by the user, and are stored in the memory unit 26.

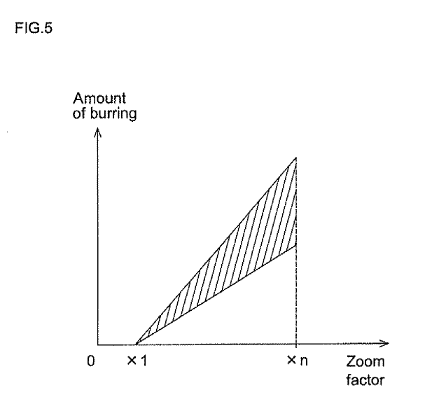

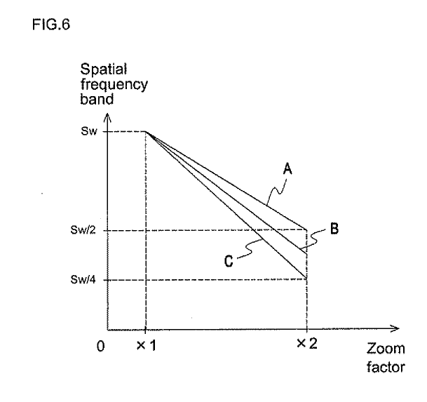

The amount of blurring is the degree of blurring artificially added by blurring processing (described later) to each of the frame images 36b to 36d between the processing start timing T1 and the processing end timing T2, and is pre-set on the basis of the zoom factor. For example, as illustrated in FIG. 5, when the zoom factor is 1 (no zoom processing), the amount of blurring is 0 (no blurring processing), and as the zoom factor increases, the amount of blurring is set so as to also increase. Specifically, for example as illustrated in FIG. 6, when the spatial frequency band of each of the frame images 36b to 36d during a zoom factor of 1 is taken as “Sw”, then in a case where the zoom factor is set in step S13 to 2, the amount of blurring is set such that the spatial frequency band of each of the frame images 36b to 36d from the zoom factor of 1 to the zoom factor of 2 gradually changes from Sw to Sw/2 (or Sw/2>spatial frequency band≧Sw/4). When the spatial frequency band during a zoom factor of 2 becomes a value greater than. Sw/2, there is a conspicuous degradation of image quality that occurs when the two-time zoom is set by electronic zoom processing, and when the spatial frequency band becomes a value smaller than Sw/4, blurring becomes excessive, wherefore the spatial frequency band during a two-time zoom is set anywhere between Sw/4 to Sw/2. Accordingly, the amount of blurring is set to a value such that an image is effectively blurred within the range in which it is possible to compensate for the degradation of image quality, in particular visually perceptible degradation in image quality, caused by the electronic zoom processing.

The amount of blurring set such that the spatial frequency band from a zoom factor of 1 to a zoom factor of 2 gradually changes from Sw to Sw/2 (graph A of FIG. 6) is smaller than the amount of blurring set such that the spatial frequency band from a zoom factor of 1 to a zoom factor of 2 gradually changes from Sw to Sw/4 (graph C of FIG. 6). Accordingly, in a case Where the user wishes for a strong degree of blurring during zoom-out, then the spatial frequency band is set as depicted in graph C of FIG. 6, i.e., the amount of blurring is set so as to increase; in a case where the user wishes for a weak degree of blurring during zoom out, then the spatial frequency band is set as depicted in graph A of FIG. 6, i.e., the amount of blurring is set so as to decrease. The spatial frequency band can be set as depicted in graph B of FIG. 6, being smaller than graph A of FIG. 6 and larger than graph C, and the amount of blurring can then be set on the basis of the set spatial frequency band. In this manner, in a case where a plurality of selectable amounts of blurring exist, the configuration may be such that the amount of blurring is pre-set prior to the start of the creation of the scenario movie, or the configuration may be such that the user is made to select an amount of blurring (high, medium, low) while the scenario movie is being created, e.g., during the processing of step S14.

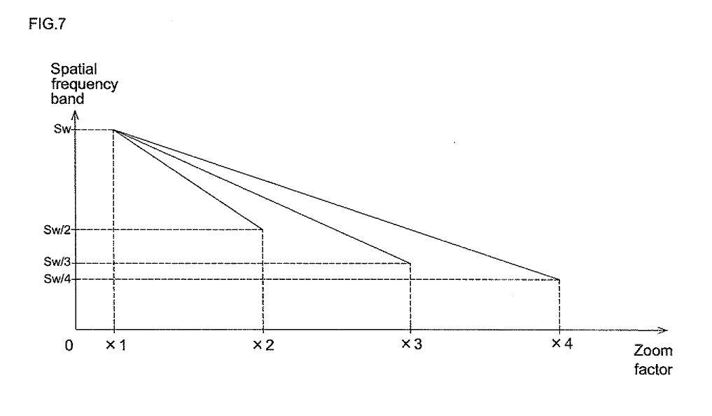

The description has included, by way of example, a case where the zoom factor is set to 2 in step S13, but in a case where the zoom factor is set to 3 or 4, then, for example as illustrated in FIG. 7, the amount of blurring is set such that the spatial frequency band of each of the frame images 36b to 36d from the zoom factor of 1 to the zoom factor of 3 (or 4) gradually changes from Sw to Sw/3 (or Sw/4). That is, the degree of blurring to be continuously added to or removed from the frame images forming the scenario movie on the basis of the amount of blurring set when the zoom factor is 2 is different from the degree of blurring to be continuously added to or removed from the frame images forming the scenario movie on the basis of the amount of blurring set when the zoom factor is 3 or 4, instead of 2.

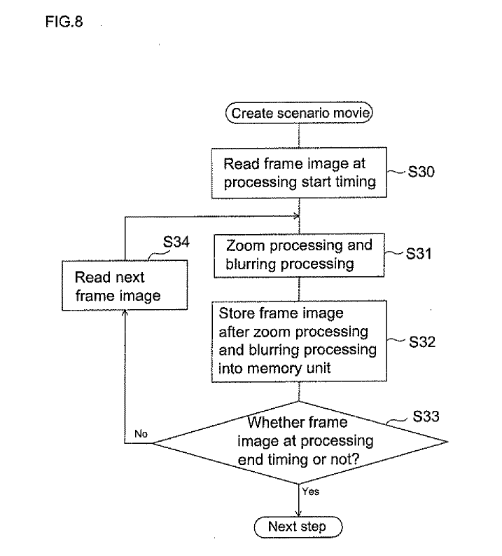

Next, the control unit 10 determines whether or not the user has given an instruction to create a scenario movie via the operating unit 24 (step S15). The control unit 10 displays, for example, an instruction screen instructing “Create scenario movie”, on the display unit 20. In a case where the determination in step S15 is that an instruction to create a scenario movie has been made (“Yes” in step S15), the control unit 10 creates a scenario movie on the basis of the original movie images (step S16). FIG. 8 is a flowchart adapted to describe the processing for creating the scenario movie in step S16 illustrated in FIG. 3.

First, the control unit 10 reads out, from the recording medium 18, the frame image 36b at the processing start timing T1 (hereinafter referred to as the initial frame image) (step S30). Then, the control unit 10 performs zoom processing and blurring processing on the frame image 36b read out in step S30 (step S31). In the following description, the zoom factor is 2 and the amount of blurring is set such that the spatial frequency band during the zoom factor of 2 becomes Sw/2.

In the case of “From zoomed in to zooming out”, a known electronic zoom processing technology or other electronic image processing technology is used to enlarge the initial frame image 36b by zooming twice, while simultaneously a known blurring processing technology or other electronic image processing technology is used to add an amount of blurring to the initial frame image 36b such that the spatial frequency band becomes Sw/2, thus blurring the initial frame image 36b, whereby a frame image 38 (see FIG. 3) is created. In the case of “From zoomed out to zooming in”, a known electronic zoom processing technology or other electronic image processing technology is used to zoom the initial frame image at the same factor, and a known blurring processing technology or other electronic image processing technology is used to add the amount of blurring to the initial frame image, which has been zoomed at the same factor, such that the spatial frequency band becomes Sw. That is, the initial frame image prior to image processing becomes the same image as the initial frame image after image processing. Accordingly, it is possible to configure such that zoom processing, blurring processing, and other image processing are not performed on the initial frame image in a case of “From zoomed out to zooming in”.

Next, the control unit 10 stores the frame image 38 after the zoom processing and the blurring processing in step S31, in the memory unit 26 (step S32). Then, a determination is made as to whether or not the frame image 38 stored in step S32 is the frame image 36d at the processing end timing T2 (hereinafter referred to as the final frame image) (step S33); in a case where the determination is that the frame image 38 is not the final frame image 36d (“No” in step S33), the control unit 10 reads out the next frame image from the recording medium 18 (step S34), and processing returns to step S31. That is, zoom processing and blurring processing (imparting or removing the “zoom effect” through electronic image processing, and imparting or removing the “blurring effect” through electronic image processing) are performed on the next frame image having been read out in step S34 (step S31). After the zoom processing and the blurring processing, the next frame image is stored in the memory unit 26 (step S32), and the processing in step S34 the next frame image is read out from the recording medium 18 as well as the processing in steps S31 to S33 are repeated until the final frame image is stored in the memory unit 26, i.e., until a determination is made in step S33 that the image is the final frame image (“Yes” in step S33).

Specifically, in a case of “From zoomed in to zooming out”, the movie images from the processing start timing T1 until the processing end timing T2 (each of the frame images) are gradually zoomed in order from a factor of 2 to a factor of 1, whereby the images are continuously reduced in size, while simultaneously blurring processing is performed on each of the frame images, such that the spatial frequency band transitions from Sw/2 to Sw and the amount of burring is gradually removed, whereby blurring is continuously removed. For example, with the frame image 36c, a frame image 40 (see FIG. 3) is created by the execution of zoom processing of a factor of about 1.5 and a predetermined blurring processing, and with the final frame image 36d, a frame image 42 is created without the execution of any zoom processing or blurring processing. In a case of “From zoomed out to zooming in”, the movie images from the processing start timing T1 until the processing end timing T2 (each of the frame images) are gradually zoomed in order from a factor of 1 to a factor of 2, whereby the images are continuously enlarged, while simultaneously blurring processing is performed on each of the frame images, such that the spatial frequency band transitions from Sw to Sw/2 and the amount of burring is gradually added, whereby blurring is continuously added. The audio corresponding to the original movie images of the period TW1 from the processing start timing T1 to the processing end timing T2 is also stored in the memory unit 26.

When scenario movie creation is terminated, the control unit 10 determines whether or not a selection has been made, by the user via the operating unit 24, to play back the scenario movie created in step S16 illustrated in FIG. 2 (step S17). The control unit 10 displays, for example, “Scenario movie created. Play back?” or another message on the display unit 20, as well as a selection screen containing an item adapted for the selection of response to the message (e.g., “Yes”, “No”, or the like), and prompts the user to select either one. In a case where a selection is made in step S17 to play back the scenario movie (“Yes” in step S17), the control unit 10 plays back the scenario movie created in step S16 and the corresponding audio, in the display unit 20 and the speaker 22 (step S18). Namely, in a case of “From zoomed in to zooming out”, the scenario movie is played back such that the frame images 38 . . . 40 . . . 42 are displayed in this order on the display unit 20, whereby there is a gradual change from a zoomed-in, unfocused state (a blurred state) to a state of zooming out while also focusing on the subject. On the other hand, in a case where no selection is made in step S17 to play back the scenario movie (“No” in step S17), the control unit 10 proceeds to the processing in step S19 without playing back the scenario movie.

Although the user selects whether or not to play back, in step S17, the scenario movie created in step S16, another possible configuration is one in which, after the scenario movie has been created in step S16, the scenario movie is played back without selection being made by the user.

Next, the control unit 10 determines whether or not there has been a selection, by the user via the operating unit 24, to record the scenario movie created in step S16 (step S19). The control unit 10 displays, for example, “Record scenario movie?” or another message on the display unit 20, as well as a selection screen containing an item adapted for the selection of response to the message (e.g., “Yes”, “No”, or the like), and prompts the user to select either one. In a case where a selection is made in step S19 to record the scenario movie (“Yes” in step S19), the control unit 10 records, in the recording medium 18, the movie image data based on the scenario movie created in step S16, as well as the corresponding audio data (step S20). Namely, a movie image compression circuit (not shown) within the control unit 10 performs, on each of the frame images stored in the memory unit 26, compression processing for movie images, and the movie image data created thereby is recorded in the recording medium 18. On the other hand, in a case where no selection is made in step S19 to record the scenario movie (“No” in step S19), the control unit 10 terminates processing without recording the scenario movie.

According to the image processing device 2 as stated in the first embodiment, it is possible to readily create a scenario movie in which the focus state and the zoom state change continuously. Namely, in the prior art, in case of a desire to manually capture a scenario movie as described above, it has been necessary to simultaneously move the focus lens and the zoom lens, and advanced operating technology has been required. However, the image processing device 2 according to this embodiment makes it possible to readily create the above-described scenario movie, i.e., movie images having an impressive visual effect, from captured movie images, without the need to have access to advanced operating technology and without the need to move the focus lens and the zoom lens.

The following is a description of an image processing device according to a second embodiment of the present invention, with reference to the accompanying drawings. The image processing device according to the second embodiment has the same configuration as the configuration of the image processing device 2 according to the first embodiment, and a description thereof has therefore been omitted; the description employs like reference numerals for like constitutional elements.

In the second embodiment, the control unit 10 detects the facial region of a person in a case where a person is present as a subject in the frame image 36b at the processing start timing T1 (see FIG. 3) or in the frame image 36d at the processing end timing T2 (see FIG. 3). The detection of the facial region employs: the color (skin-color) detection; the detection of the eyes, the nose, the mouth, or other feature part forming the face; the detection of the contour parts of the face; or another known technique. The control unit 10 then sets the zoom factor on the basis of the results from the facial region detection in the frame image.

That is, after having terminated the processing of steps S10 and S11 illustrated in FIG. 2, the control unit 10, in a case of having determined that the processing start timing T1 and the processing end timing T2 have been designated in step S12 (“Yes” in step S12), causes the user to designate a zoom direction via the operating unit 24.

Then, the control unit 10, rather than the processing in step S13, instead determines whether or not the user has designated a zoom direction and, in a case where the determination is that the zoom direction has been designated, detects the facial region of a person in the frame image 36b at the processing start timing T1 or in the frame image 36d at the processing end timing T2. Specifically, in a case where “From zoomed in to zooming out” has been selected as the zoom direction, then facial region of the person in the frame image 36b at the processing start timing T1 is detected, and the zoom factor is set on the basis of the size of the facial region relative to the overall size of the frame image 36b (step S14). That is, the zoom factor is set such that the size of the facial region relative to the display screen of the display unit 20, i.e., relative to the size of the frame image, becomes a predetermined size. The predetermined size is pre-set and stored in a memory or the like (not shown).

On the other hand, in a case where “From zoomed out to zooming in” has been selected as the zoom direction, then the facial region of the person in the frame image 36d at the processing end timing T2 is detected, and the zoom factor is set on the basis of the size of the facial region relative to the overall size of the frame image 36d (step S14).

Next, the control unit 10 sets the amount of blurring on the basis of the zoom direction designated by the user and the set zoom factor (step S14), and stores, in the memory unit 26, the zoom direction, the zoom factor, and the amount of blurring. Then, the control unit 10 proceeds to the processing of step S15 and executes the processing in steps S15 to S20.

According to the image processing device as stated in the second embodiment, in addition to the effects of the image processing device 2 according to the first embodiment, the zoom factor can be automatically set on the basis of the results from the detection of the facial region. Accordingly, it becomes possible to create movie images in which the focus state and the zoom state change continuously and more precisely and easily, i.e., the movie images having the impressive visual effect.

In each of the embodiments described above, the original movie images are used to create a scenario movie in which there is a change from a zoomed-in, unfocused state to a state of zooming out while also focusing on the subject, or a scenario, movie in which there is a change from a zoomed-out state focused on the subject to a state of zooming in while also becoming unfocused; however, the technology according to the present invention can also be employed to use the original movie images to create a scenario movie in which there is a change from a zoomed-out, unfocused state to a state of zooming in while also focusing on the subject, or a scenario movie in which there is a change from a zoomed-in state focused on the subject to a state of zooming out while also unfocusing on the subject. It is also possible to use the original movie images to create scenario movies in which there is a change from zoomed in to zooming out or a change from zoomed out to zooming in, while the state of being focused on the subject is maintained. In such cases, the zoom direction, the zoom factor, and the amount of blurring are all set in a manner similar to the setting in each of the embodiments described above.

In each of the embodiments described above, there is no setting for an upper limit to the length of a period of the time TW1 from the processing start timing T1 to the processing end timing T2, but it is possible to configure a setting for an upper limit value for the period of time TW1, such that there is no adverse effect on the impressive visual effect of the scenario movie created in each of the embodiments. For example, an upper limit time period of the period of time TW1 is given as a period of time in the range where effective visual confirmation of the zoom changes or focus changes of the scenario movie is possible (for example, 10 seconds or the like) on the basis of the zoom factor, i.e., for each of the settable zoom factors. In such a case, in a case where the user has designated a period of time TW1 greater than the upper limit time period, the configuration is such that no scenario movie will be created for the movie images greater than the upper limit time period. For example, in case where, the processing start timing T1 having been initially designated and the processing end timing T2 having been subsequently designated, the period of time TW1 is greater than the upper limit time period, then the scenario movie is created for the movie images from the processing start timing T1 until the upper limit time period. In this manner, it is possible to pre-set, on the basis of the sequence of designation of the processing start timing T1 and the processing end timing T2 and other factors, whether the scenario movie will be created for the movie images, for as long as a particular upper limit time, from the processing start timing T1 to the processing end timing T2.

Further, instead of setting an upper limit value for the period of time TW1, another possible configuration is one in which an upper limit value is set for the zoom factor in accordance with the length of the period of time TW1, the zoom factor then being set so as to be within the set upper limit value of the zoom factor. For example, when the processing start timing T1 and the processing end timing T2 have been designated by the user, the control unit 10 refers to the upper limit value of the zoom factor set in accordance with the length of the period of time TW1 from the processing start timing T1 to the processing end timing T2, on the basis of the reference result and controls such that the user is unable to designate a zoom factor greater than the upper limit value. For example, the control is such that the user is unable to input a value greater than the upper limit value, or, in the screen 44 illustrated in FIG. 4, is unable to set the size of the designation box 44 to a size indicating a zoom factor greater than the upper limit value.

Also, although in each of the embodiments described above the zoom effect and the blurring effect through image processing are pre-set so as to gradually change in a linear (straight) manner, the configuration may also be such that it is possible to select whether the zoom effect and the blurring effect through image processing should change in a linear manner or change in a non-linear (non-straight, or curved) manner. The configuration may also be such that it is also possible for the user to appropriately select whether the manner in which the zoom effect and the blurring effect change should be to change as depicted by the same manner of change (such as straight, sloped manner when the change is straight, or a curve-shaped manner or bent manner when the change is curved) or to change by different manners of change (for example, as depicted by different curves).

Further, although each of the embodiments described above has described a case where the degree (amount or amount of change) of the zoom effect and the blurring effect changes gradually in a linear (straight) manner as an example in which the zoom and blurring effect (amount of effect) have time-series changes, the user may also be permitted to select a case where, rather than the zoom effect and the blurring effect changing continuously, the time-series changes of the degree of the zoom effect and the blurring effect are made to change in a step-wise manner. Examples of the aforementioned non-linear (curved) changes include S-shaped curved changes, Bezier curve-shaped changes, parabola-shaped changes, and the like. The configuration may also be such that the user is permitted to select such curved shapes as desired.

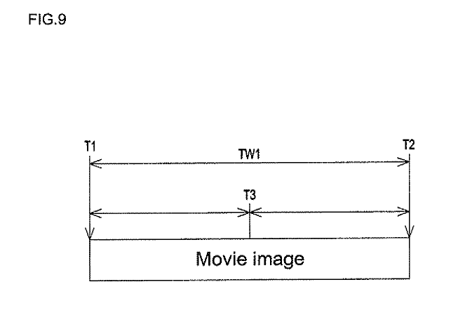

Also, in each of the embodiments described above, the “original movie images (movie images that have been captured and recorded in the recording medium)” undergo the aforesaid zoom processing and blurring processing in parallel to create a scenario movie in which there is a change from a zoomed-in, unfocused state to a state of zooming out while also focusing on the subject, or a scenario movie in which there is a change from a zoomed-out state focused on the subject to a state of zooming in and while also unfocusing. However, the scenario movie may also be created through a different sequence (namely, image processing different from the image processing for executing the zoom processing and the blurring processing in parallel). For example, the “original movie images” may first undergo zoom processing, and then the blurring processing. For example, when a scenario movie is created, in a case of “From zoomed in to zooming out”, a predetermined timing T3 is set between the processing start timing T1 and the processing end timing T2, as illustrated in FIG. 9, and the movie images from the processing start timing T1 to the predetermined timing T3 are continuously reduced through sequential, gradual zoom processing from a factor of 2 to a factor of 1. Then, after the zoom processing is complete, blurring is continuously removed through blurring processing in which the spatial frequency band transitions from Sw/2 to Sw and the amount of blurring is gradually removed in each of the frame images of the movie images from the predetermined timing T3 to the processing end timing T2. In a case of “From zoomed out to zooming in”, the movie images from the processing start timing T1 to the predetermined timing T3 are continuously enlarged through sequential, gradual zoom processing from a factor of 1 to a factor of 2. Then, after the zoom processing is complete, blurring is continuously added through blurring processing in which the spatial frequency band transitions from Sw to Sw/2 and the amount of blurring is gradually added in each of the frame images of the movie images from the predetermined timing T3 to the processing end timing T2. In such cases, the blurring processing may also be performed first, and then followed by the zoom processing.

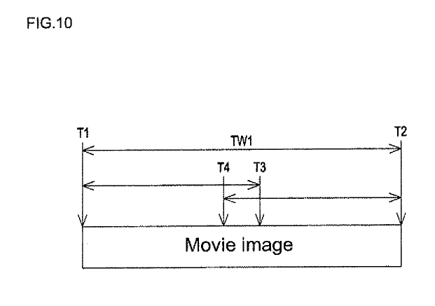

Further, as illustrated in FIG. 10, a predetermined timing T3 at which the zoom processing is complete and a predetermined timing T4 at which the blurring processing starts may also be set, where zoom processing is performed on the movie images from the processing start timing T1 to the predetermined timing T3, and blurring processing is performed on the movie images from the predetermined timing T4 to the processing end timing T2. That is, there may be a section from the predetermined timing T4 to the predetermined timing T3 in which the zoom processing and the blurring processing are performed simultaneously. In such cases, the blurring processing may also be performed first, and then followed by the zoom processing.

In such cases, the configuration may be such that the user is able to set any desired predetermined timings T3 and T4, or the configuration may be such that the same are automatically set at positions that have been pre-designated between the processing start timing T1 and the processing end timing T2.

The description of each of the embodiments described above assumes that the “original movie images” are movie images that contain no zoom changes or focus changes. However, movie images that do contain scenes having changes in the zoom factor and/or changes in the focus state may also be used as the “original movie images”. For example, during imaging to obtain the “original movie images”, imaging may be performed while the zoom lens is shifting, or imaging may be performed while the focus lens is moving, or imaging may be performed while electronic zoom processing is being performed. It is still possible to generate a scenario movie as in the embodiments above by using such a technique to obtain movie images partially containing zoom-change scenes or focus-change scenes for use as the “original movie images”. It is noted that whether to use optical zoom processing through the imaging lens or to use zoom processing employing electronic image processing technology, when the movie images containing zoom-change scenes are obtained as the “original movie images”, may be selected by the user by using the operating unit 24.

As a further example, when “original movie images (including zoom-change scenes)” are used to create a scenario movie combining the zoom effect and the focus effect, focus processing (blurring processing) through electronic image processing technology may be performed on such “original movie images”. A possible method for more effectively generating the scenario movie would be to record, in an image file tag for “original movie images” recorded in the recording medium, the position (section) at which the zoom processing (for example, optical zoom processing through the imaging lens) has been performed when “original movie images (including zoom-change scenes)” are captured. In so doing, when the scenario movie is generated after the imaging, the image processing device can automatically select the zoom-change scenes from among the “original movie images (including zoom-change scenes)” on the basis of the position information (zoom section information) recorded in such a tag. Also, the image processing device performs electronic focus processing (blurring processing) on a section automatically determined on the basis of the automatically selected scenes (which may be said scene section, or may be a predetermined section that includes said scenes, or may be a predetermined section automatically selected on the basis of said scenes (for example, a “section immediately before” or a “section immediately after” said scenes). The scenario movie can thereby be more effectively generated. With such a generation method, for example, a section coinciding with the section at which the optical zoom processing is performed among the original movie images is set as the section at which electronic focus processing is to be performed, and the set section undergoes electronic focus processing, wherefore a scenario movie as described in the embodiments above can be readily generated.

Next, a description will be provided for a case where movie images are captured and recorded in the recording medium while optical focus processing (blurring processing) through the imaging lens (the focus lens) is being performed, and the recorded movie images are used as the “original movie images (including focus-change scenes)” to create a scenario movie. A scenario movie combining the zoom effect and the focus effect can be generated through zoom processing by electronic image processing technology performed on the “original movie images (including focus-change scenes)”. Specifically, similar to the case described above (using the “original movie images (including zoom-change scenes)” to generate a scenario movie), when during the capturing of the “original movie images” information indicating the position (section) of the focus-change scenes among the movie images is recorded in an image file tag for the movie images, the tag information can be used to automatically select and automatically determine the section at which electronic image processing (for example, zoom processing) is to be performed, similar to the description above. Therefore, the use of the tag information makes it possible to readily use the original movie images including focus-change scenes to generate a scenario movie including both focus changes and the zoom effect.

Also, in the case of using movie images including zoom-change scenes or focus-change scenes as the “original movie images” to generate a scenario movie as described above, it is further possible for the user to set, as desired, a processing section intended for electronic image processing (the zoom effect and/or blurring effect).

Also, irrespective of whether the “original movie images” include or do not include zoom-change scenes and/or focus-change scenes, when such “original movie images” are used to generate a scenario movie as described above, the configuration may be such that only one of either the zoom effect or the blurring effect is performed as electronic image processing, or alternatively such that both effects are performed. The configuration may also be such that the user is allowed to select, as desired, which effect should be imparted to the original movie images through the image processing described above.

The above-described embodiments have been recited in order to facilitate understanding of the present invention, and are not recited in order to limit the present invention. Accordingly, in effect, each element disclosed in the above-described embodiments also includes all design changes and equivalents falling within the technical scope of the present invention.

1. An image processing device, comprising:
an image processing unit that executes, on movie images that have been recorded in a recording medium, image processing of at least one of a first image processing for imparting or removing an electronic zoom effect, or a second image processing for imparting or removing an electronic blurring effect;
a first setting unit that sets, in the movie images, a processing section in which the image processing is to be executed by the image processing unit;
a second setting unit that sets, relative to the processing section in the movie images, at least one of either the zoom factor having time-series changes to be imparted by the first image processing or the amount of blurring having time-series changes to be imparted by the second image processing; and
a movie image data creation unit that creates movie image data including the movie images on which the image processing has been performed by the image processing unit, on the basis of the content set by the first setting unit and the second setting unit.

2. The image processing device according to claim 1, wherein
the image processing unit executes, on the processing section, the first image processing based on the content set by the second setting unit, and also executes the second image processing based on the content set by the second setting unit.

3. The image processing device according to claim 1, wherein
the first setting unit independently sets a processing section in which the first image processing is to be executed and a processing section in which the second image processing is to be executed.

4. The image processing device according to claim 2, wherein
the first setting unit sets a first timing in the movie images and also a second timing that is different from the first timing; and
the second setting unit sets at least one of the zoom factor or the amount of blurring of the movie images at the second timing.

5. The image processing device according to claim 4, wherein
in a case where the zoom factor has been set by the second setting unit and the first timing is earlier than the second timing, the image processing unit executes, on the movie images in the section from the first timing to the second timing, image processing for enlarging the movie images in time series up to the zoom factor set by the second setting unit; and
in a case where the zoom factor has been set by the second setting unit and the first timing is later than the second timing, the image processing unit executes image processing for electronically enlarging the movie image at the second timing up to the zoom factor set by the second setting unit, and thereafter reducing the movie images from the second timing to the first timing by removing the zoom effect in time series from said movie image.

6. The image processing device according to claim 4, wherein
in a case where the amount of blurring has been set by the second setting unit and the first timing is earlier than the second timing, the image processing unit executes, on the movie images in the section from the first timing to the second timing, image processing for imparting blurring up to the amount of blurring set by the second setting unit; and
in a case where the amount of blurring has been set by the second setting unit and the first timing is later than the second timing, the image processing unit executes image processing for electronically adding blurring of the amount of blurring set by the second setting unit to the movie image at the second timing, and thereafter removing in time series the blurring added to said movie image from the movie images from the second timing to the first timing.

7. The image processing device according to claim 6, wherein
the image processing unit executes image processing on the movie images in the section from the first timing to the second timing, the image processing being adapted to impart or remove the zoom effect and simultaneously add or remove the blurring effect in time series for the movie images, on the basis of the zoom factor and the amount of blurring set by the second setting unit.

8. The image processing device according to claim 1, wherein
the movie images include movie images captured during an optical zoom operation by an imaging lens, and
the image processing unit executes the second image processing on the movie images.

9. The image processing device according to claim 1, wherein
the movie images include movie images captured during an optical focus operation by an imaging lens, and
the image processing unit executes the first image processing on the movie images.

10. The image processing device according to claim 4, comprising:
a display unit that displays the movie images recorded in the recording medium
the second setting unit sets the zoom factor for the movie image at the second timing, on the movie image displayed on the display screen of the display unit.

11. The image processing device according to claim 4, comprising:
a detection unit that detects the size of a facial region of a person relative to the size of the movie image in a case where the person is present as a subject in said movie image at the first timing, wherein
the second setting unit sets the zoom factor on the basis of the size of the facial region detected by the detection unit.

12. The image processing device according to claim 4, wherein
the second setting unit sets the amount of blurring on the basis of the zoom factor.

13. The image processing device according to claim 12, wherein
the degree of blurring to be continuously added to or removed from the movie images on the basis of the amount of blurring set on the basis of a predetermined zoom factor is different from the degree of blurring to be added to or removed from the movie images in time series on the basis of the amount of blurring set on the basis of another zoom factor different from the predetermined zoom factor.

14. The image processing device according to claim 12, comprising:
a selection unit that selects one among a plurality of amounts of blurring in a case where there exist a plurality of amounts of blurring set on the basis of a predetermined zoom factor, wherein
the second setting unit sets the amount of blurring on the basis of the selection results by the selection unit.

15. The image processing device according to claim 4, wherein
the movie image at the first timing prior to being image-processed by the image processing unit is the movie image at the first timing after having been image-processed by the image processing unit.

16. The image processing device according to claim 4, wherein
an upper limit value of the time difference between the first timing and the second timing is determined for each magnification rate set by the second setting unit.

17. The image processing device according to claim 4, wherein
the second setting unit sets the zoom factor to within an upper limit value of the zoom factor determined in accordance with the time difference between the first timing and the second timing.
